(19) United States
(12) Patent Application Publication
(10) Pub. No.: US 2016/0113304 A1
(43) Pub. Date: Apr. 28, 2016

(54) Chewing Gum Comprising Chitosan For Use In Reduction Of The Level Of Free Phosphorus Compounds In The Digestive Juice

(71) Applicants: Lars Christian Kure Steenberg, Vejle (DK); Heidi Ziegler Bruun, Vejle Ost (DK); Kenneth Due Nielsen, Middelfart (DK)

(72) Inventors: Lars Christian Kure Steenberg, Vejle (DK); Heidi Ziegler Bruun, Vejle Ost (DK); Kenneth Due Nielsen, Middelfart (DK)

(21) Appl. No.: 14/833,982

(22) Filed: Aug. 24, 2015

Related U.S. Application Data
(62) Division of application No. 14/112,772, filed on Oct. 18, 2013, now abandoned.

(30) Foreign Application Priority Data
Apr. 20, 2011 (DK) PCT/DK2011/000035
Dec. 5, 2011 (DK) PA 2011 00945
Dec. 12, 2011 (DK) PA 2011 00963

(51) Int. Cl. A23G 4/10; A23G 4/06; A23G 4/20

(52) U.S. Cl. CPC A23G 4/10; A23G 4/20; A23G 4/06; A23V 2002/00

(57) ABSTRACT

The invention relates to the non-medical use of a phosphorus compound binding agent in a slow release oral delivery system comprising chewing gum, wherein said phosphorus compound binding agent is chitosan, for reducing the level of free phosphorus compounds in the digestive juice.

### TECHNICAL FIELD

The present invention relates to the field of slow release oral delivery systems, such as chewing gums. In particular the invention pertains to reducing phosphorus level in users in need thereof.

### BACKGROUND

Phosphorus intake occurs with food, and it is well-known that the amount of phosphorus in food varies a lot. Meat, for example, is rich in phosphorus whereas low-protein food may be lower in phosphorus-content. However, a complete avoidance of all kinds of phosphorus-rich food may result in malnutrition.

EP 1 827 386 describes the use of phosphorous binding agents, such as chitosan, to lower phosphorous-levels in patients suffering from hyperphosphatemia.

Chitosan has been seen to be highly suitable to reduce phosphorus-levels as chitosan is not digestible and passes through the digestive tract without being absorbed and therefore does not add any calories. As such chitosan may advantageously be used as a non-pharmaceutical food supplement e.g. in a population that is particularly exposed to risk of phosphorus-related diseases.

A problem related to this prior art is that rather large amounts of chitosan need to be used in order to obtain a satisfying lowering of the phosphorus level.

It is therefore an object of the present invention to establish an improved method of lowering phosphorus-levels in users in need thereof.

### SUMMARY OF THE PRESENT INVENTION

The invention relates to the non-medical use of a phosphorus compound binding agent in a slow release oral delivery system comprising chewing gum, wherein said phosphorus compound binding agent is chitosan, for reducing the level of free phosphorus compounds in the digestive juice.

According to the present invention it has surprisingly been found that the phosphorus binding ability of chitosan can be very efficiently utilized by incorporating chitosan in a chewing gum formulation. The chewing gum is kept in the mouth for prolonged periods and the chitosan from the chewing gum is effectively kept in contact with the phosphorus present in the saliva of the user. Chitosan may be slowly released from the chewing gum and, after binding phosphorus in the saliva, the released chitosan, now comprising bound phosphorus compound, may be swallowed, whereby the bound phosphorus may pass through the gastrointestinal tract without entering the bloodstream. Hereby the amount of free phosphorus in the digestive juice may be reduced.

Hereby, by using the present oral delivery system as a food supplement, already known advantageous results of lowering phosphorus-levels in the digestive juice of users may be obtained to an even higher degree.

Lowering of phosphorus-levels in the digestive juice of users may be pleasant for a variety of users, e.g. people suffering from hyperphosphatemia.

In order to bind as much phosphorus as possible, oral delivery systems according to embodiments of the present invention are characterized by continuous slow release characteristics of the chitosan and the organic acid.

Moreover, the chewing gum may preferably be retained in the mouth for as long time as necessary to draw close to exhaustion of the phosphorus binding agent.

According to an embodiment of the present invention, said use is non-therapeutic.

According to an embodiment of the invention, the slow oral delivery system may be used as a Food for Special Purposes to reduce the level of phosphorus in the digestive juice.

According to embodiments of the present invention, the oral delivery system is suitable for being retained for a long time in the mouth of the user. A preferred embodiment is chewing gum, since it can be retained in the mouth for an extended period, even hours. Furthermore, it allows the user to control the permanence of the chitosan in the mouth.

Finally, by letting the oral delivery system comprise a chewing gum, further advantages are obtained. Phosphate sequestration may occur in the mouth, in particular from saliva, the major source of recirculating phosphorus. Therefore, once the chitosan has absorbed amounts of phosphorus compounds, the chewing gum can be discarded and a new chewing gum can be taken. This avoids swallowing the composition and engaging the gastrointestinal tract with the presence of a composition loaded with phosphorus, so that the user has not to worry about a possible release of phosphorus in the gastrointestinal tract or the effective elimination of the composition.

In an embodiment of the invention said slow release oral delivery system further comprises an organic acid.

According to preferred embodiments of the present invention, it has surprisingly been found that the phosphorus-binding ability of chitosan may be improved by combining chitosan with an organic acid in a slow release oral delivery system.

According to an embodiment of the present invention, the benefits of chitosan may be boosted by using ascorbic acid as the organic acid. Both D-Ascorbic acid and L-ascorbic acid may be used, and according to the present invention it has been shown that these are preferable among the organic acids for enhancing chitosan's ability to reduce the level of free phosphorus in the digestive juice. Consequently, the combination of chitosan and ascorbic acid may result in even lower phosphorus levels.

In an embodiment of the invention the reduction of the level of free phosphorous compounds is increased by between 5 and 50%, such as 15-40% when compared to the same oral delivery system without organic acid.

It has surprisingly been discovered that the combination of chitosan and an organic acid enhance the binding capacity of chitosan with respect to free phosphorous compounds when used in a slow release oral delivery system.

For example, the amount of phosphate in the saliva may be reduced much more effectively by combining chitosan and an organic acid in an oral delivery system when compared to the same delivery system without organic acid added.

In an embodiment of the invention, the dosage of said combination of a phosphorus compound binding agent and an organic acid is in an amount sufficient to reducing the level of free phosphorus compounds in the digestive juice with at least 10%, such as 20% or 30%.

Such reducing of level of free phosphorus compounds in the digestive juice may e.g. be measured with respect to physiological level or as % by weight.

In an embodiment of the invention said chewing gum is batch mixed or extruded chewing gum.

In an embodiment of the invention, said chewing gum is a compressed chewing gum. In a compressed chewing gum, typically, gum base granules are mixed with further chewing gum ingredients, such as sweeteners and flavor. This final mix of granules is then compressed under high pressure into a chewing gum tablet.

The result is that an initial chew of a compressed chewing gum results in an initial disintegration of the chewing gum followed by a gathering of the water-insoluble ingredients over time upon chewing. Hereby, a larger amount of the chitosan and the organic acid may be initially quickly released inside the mouth cavity, thereby facilitating initial quick larger uptake possibilities for phosphorus compounds in the mouth of the user. However, the advantages described above related to chewing gum in general still applies, since the end product may still be discarded as any kind of chewing gum. Part of the initially released chitosan may actually be trapped in the gum base again during the chewing process, whereby the phosphorus compounds trapped by this part of the chitosan will also be trapped in the gum base.

A particular advantage related to compressed chewing gum is the possibility of using mild conditions with respect to for example temperature in the production process. This may have implications for an easier and/or safer processing of the added organic acids and chitosan.

In an embodiment of the invention said slow release oral delivery system further comprises at least one delivery vehicle and/or excipient selected from the group consisting of lactose anhydrous or monohydrate, povidone, microcystalline cellulose, hydroxypropylcellulose, sodium croscaramellose, magnesium stearate, E171, E172, mannitol, sodium laurylsulphate, ipromellose, methacrylic acid copolymer, macrogol, magnesium stearate, gelatine, saccharose, starch, sorbitol, flavours, sodium saccharine, colloidal silica, titanium dioxide, maltitol syrup, gum arabic, glycerol, aspartame, hydrogenated vegetal oil, sorbitol, citric acid, pectin, caramel, sucrose and methylcellulose.

In an embodiment of the invention the level of free phosphorus compounds in at least one selected from the group consisting of saliva, gastric juice, pancreatic juice, bile, and intestinal juice is reduced.

In an embodiment of the invention the level of free phosphorus compounds in the saliva is reduced.

In an embodiment of the invention said chitosan has a molecular weight of above 2 000 Da.

In an embodiment of the invention said chitosan has a molecular weight of above 10 000 Da.

A higher molecular weight of the chitosan may result in a more lipophilic chitosan product better suitable for interacting with the gum base of the chewing gum. At the same time, the ability of chitosan to attract water may still be substantial even when relatively high molecular weight chitosan is used in chewing gum, despite the fact that the chitosan is embedded in a lipophilic gum base.

In an embodiment of the invention said chitosan has a molecular weight of above 30.000 Da, preferably above 50.000 Da.

A higher molecular weight of the chitosan may result in a more lipophilic chitosan product better suitable for interacting with the gum base of the chewing gum. At the same time, the ability of chitosan to attract water may still be substantial even when relatively high molecular weight chitosan is used in chewing gum, despite the fact that the chitosan is embedded in a lipophilic gum base.

In an embodiment of the invention said chitosan has a molecular weight below 500 000 Da, preferably below 250 000 Da, most preferably below 100 000 Da.

In an embodiment of the invention said chitosan has a degree of deacetylation above 85%, preferably above 90%, most preferably above 95%.

In an embodiment of the invention said chitosan has fat binding affinity.

In an embodiment of the invention said oral delivery system comprises said chitosan and said organic acid in a ratio between 1:4 and 40:1 by weight, preferably between 1:1 and 10:1 by weight.

In an embodiment of the invention the total amount of said chitosan taken by a user on a single day is between 0.001 and 30 g, preferably between 0.01 and 20 g, more preferably between 0.015 and 10 g, most preferably between 0.025 and 3.0 g.

In an embodiment of the invention the total amount of said chitosan taken by a user on a single day is between 5 and 100 mg, preferably between 10 and 80 mg.

In an embodiment of the invention at least part of said chitosan is retained in the chewing gum or the remaining gum base after chewing.

By retaining chitosan in the chewing gum after the chewing process, free phosphorous compounds may be bound by the chitosan still in the chewing gum and disposal of the chewing gum after chewing will remove the chitosan-bound phosphorous compounds from the body. Thereby, a passage of the chitosan-bound phosphorous compounds retained in the chewing gum through the gastrointestinal tract is avoided. This may be advantageous when compared to alternative delivery vehicles such as tablets, lozenges etc.

In a further advantageous embodiment of the invention, the chitosan is retained in the gum base of the chewing gum.

In another embodiment of the invention the synergy between chitosan and organic acid in binding free phosphorous compounds is utilized while both chitosan and organic acid are encapsulated in a gum base of a chewing gum.

In this way, a delivery system that may effectively bind phosphorous compounds within a gum base of a chewing gum has been obtained.

In an embodiment of the invention an amount of at least 10%, such as at least 20, 30 or 40% of said chitosan is retained in the chewing gum after chewing, said amount measured relative to the chitosan content in the chewing gum prior to chewing.

In an embodiment of the invention both chitosan and phosphorous compounds are retained in the chewing gum and hereby removed from the body when the chewing gum is discarded.

In an embodiment of the invention said organic acid is selected from the group consisting of ascorbic acid, malic acid, and tartaric acid.

It has surprisingly been found that some organic acids significantly enhance the phosphorus compound binding ability of chitosan when applied in chewing gum. This interaction is somewhat surprising because it is believed that the organic acids are more hydrophilic than chitosan. Tests show that quite hydrophilic organic acids such as malic acid and tartaric acid and ascorbic acid produce this enhancement effect despite the fact that water soluble components release differently from chewing gum than more hydrophobic components that tend to release slower from the by nature water insoluble gum base. The observed synergy is surprising because interactions between chitosan and organic acid would be expected to be limited in chewing gum due to the expected different release profiles. Thereby it would be expected that there would be a lack of availability of organic acid in the gum base. Particularly suitable organic acids could be those already approved for use in food. Acids comprising 3-10 carbon atoms are also candidates for providing a good synergistic effect in this context.

The explained synergistic effect may be promoted by the ability of chitosan to attract water into the chewing gum/gum base, since chitosan may have a pronounced water uptake.

The invention further relates to a method of reducing the level of free phosphorus compounds in the digestive juice by the use of a combination of a phosphorus compound binding agent in a slow release oral delivery system comprising chewing gum, wherein said phosphorus compound binding agent is chitosan.

In an embodiment of the invention said phosphorus compound binding agent is chitosan.

In an embodiment of the invention said chewing gum further comprises at least one organic acid.

In an embodiment of the invention the chewing gum comprises organic acid in an amount of 0.01 to 10% by weight of the chewing gum, 0.02 to 5% by weight of the chewing gum, 0.03 to 3% by weight of the chewing gum, 0.05 to 2.0 by weight of the chewing gum or 0.1 to 1.0% of the chewing gum.

It has surprisingly been found that some organic acids significantly enhance the phosphorus compound binding ability of chitosan when applied in chewing gum. This interaction is somewhat surprising because it is believed that the organic acids are more hydrophilic than chitosan. Tests show that quite hydrophilic organic acids such as malic acid and tartaric acid and ascorbic acid produce this enhancement effect despite the fact that water soluble components release differently from chewing gum than more hydrophobic components that tend to release slower from the by nature water insoluble gum base. The observed synergy is surprising because interactions between chitosan and organic acid would be expected to be limited in chewing gum due to the expected different release profiles. Thereby it would be expected that there would be a lack of availability of organic acid in the gum base. Particularly suitable organic acids could be those already approved for use in food. Acids comprising 3-10 carbon atoms are also candidates for providing a good synergistic effect in this context.

The explained synergistic effect may be promoted by the ability of chitosan to attract water into the chewing gum/gum base, since chitosan may have a pronounced water uptake.

In an embodiment of the invention said organic acid is selected from the group consisting of ascorbic acid, malic acid, and tartaric acid.

In an embodiment of the invention said chewing gum mixed chewing gum.

In an embodiment of the invention said mixed chewing gum comprises gum base in an amount of 10 to 70% by weight of the chewing gum, 15 to 60% by weight of the chewing gum or preferably 35 to 50% by weight of the chewing gum.

In an embodiment of the invention said chewing gum is compressed chewing gum. In a compressed chewing gum, typically, gum base granules are mixed with further chewing gum ingredients, such as sweeteners and flavor. This final mix of granules is then compressed under high pressure into a chewing gum tablet.

The result is that an initial chew of a compressed chewing gum results in an initial disintegration of the chewing gum followed by a gathering of the water-insoluble ingredients over time upon chewing. Hereby, a larger amount of the chitosan and the organic acid may be initially quickly be released inside the mouth cavity, thereby facilitating initial quick larger uptake possibilities for phosphorus compounds in the mouth of the user. However, the advantages described above related to chewing gum in general still apply, since the end product may still be discarded as any kind of chewing gum. Part of the initially released chitosan may actually be trapped in the gum base again during the chewing process, whereby the phosphorus compounds trapped by this part of the chitosan will also be trapped in the gum base.

A particular advantage related to compressed chewing gum is the possibility of using mild conditions with respect to for example temperature in the production process. This may have implications for an easier and/or safer processing of the added organic acids and chitosan.

A surprising advantageous result is obtained when the chitosan is added to the chewing gum granules without any pre-mixing with the gum base.

It is surprising that the chitosan is chewed into the gum base as there is usually a very fast and complete release of components not pre-mixed with the gum base.

In an embodiment of the invention said compressed chewing gum comprises gum base in an amount of 5 to 50% by weight of the chewing gum, 8 to 40% by weight of the chewing gum or preferably 10 to 30% by weight of the chewing gum.

In an embodiment of the invention said chewing gum comprises sweetener in an amount of 5 to 80% of the chewing gum, preferably 10 to 60% by weight of the chewing gum.

In an embodiment of the invention the chewing gum comprises chitosan in an amount of 0.1 to 10% by weight of the chewing gum, 0.2 to 5% by weight of the chewing gum, 0.3 to 3% by weight of the chewing gum, 0.4 to 2% by weight of the chewing gum or 0.5 to 1% by weight of the chewing gum.

In an embodiment of the invention a chewing gum tablet comprises chitosan in an amount of 5 to 100 mg, 10 to 80 mg, 15 to 60 mg or 20-40 mg.

In an embodiment of the invention the ratio between the amount of chitosan and the amount of gum base in the chewing gum is between 0.001 to 0.15, preferably between 0.001 to 0.1, more preferably between 0.001 to 0.08 and most preferred between 0.001 to 0.05.

In an embodiment of the invention the chewing gum is compressed and comprises chewing gum granules, wherein said chewing gum granules comprises gum base, wherein said chewing gum tablet comprises a gum base content of at least 5%, preferably at least 10% by weight of the tablet,

wherein said chewing gum tablet comprises chitosan in an amount of at least 1%, preferably at least 3% by weight of the tablet,

wherein said chitosan has a molecular weight of above 30.000 Da, preferably above 50.000 Da,

wherein said chitosan has a degree of deacetylation above 85%, preferably above 90%, most preferably above 95%,

wherein said chewing gum tablet comprises ascorbic acid in an amount of at least 0.1%, preferably at least 0.5% by weight of the tablet.

In an embodiment of the invention said chewing gum tablet has a gum base content of 5-90%, preferably 30-60% by weight of the tablet,

said chewing gum tablet comprises chitosan in an amount of at least 0.05%, such as at least 0.2% by weight of the tablet,said chitosan has a molecular weight of above 30.000 Da, preferably above 50.000 Da, said chitosan has a degree of deacetylation above 85%, preferably above 90%, most preferably above 95% and said chewing gum tablet comprises ascorbic acid in an amount of at least 0.1%, preferably at least 0.5% by weight of the tablet.

In an embodiment of the invention said chewing gum tablet comprises chewing gum granules, wherein said chewing gum granules comprises gum base, said chewing gum tablet has a gum base content of 5-90%, preferably 30-60% by weight of the tablet, said chewing gum tablet comprises chitosan in an amount of at least 0.1%, preferably at least 0.3% by weight of the tablet, said chitosan has a molecular weight of above 30.000 Da, preferably above 50.000 Da, said chitosan has a degree of deacetylation above 85%, preferably above 90%, most preferably above 95%, and said chewing gum tablet comprises ascorbic acid in an amount of at least 0.1%, preferably at least 0.5% by weight of the tablet.

In an embodiment of the invention, the combined amount of emulsifier and chitosan in the chewing gum is less than 10% by weight of the chewing gum.

Depending on the type of gum base and chitosan used in the chewing gum, chitosan may have an emulsifying effect on the gum base and it becomes important to adjust the amount of traditional emulsifier accordingly.

The invention also relates to a phosphorus compound binding agent in a slow release oral delivery system comprising chewing gum for reducing the level of free phosphorus compounds in the digestive juice, for the support of treatment of patients with chronic renal insufficiency, wherein said phosphorus compound binding agent is chitosan.

In an embodiment of the invention said phosphorus compound binding agent is chitosan and the chewing gum further comprises an organic acid.

In an embodiment of the invention the phosphorus compound binding agent in the chewing gum is used as a dietary supplement.

In an embodiment of the invention the phosphorus compound binding agent in the chewing gum is used as a food for special medical purpose.

In an embodiment of the invention the phosphorus compound binding agent in the chewing gum is used as a medical food.

In an embodiment of the invention the phosphorus compound binding agent in the chewing gum is used as a medical device.

In an embodiment of the invention the phosphorus compound binding agent in the chewing gum is used as a herbal supplement.

In an embodiment of the invention the phosphorus compound binding agent in the chewing gum is used as a food.

In an embodiment of the invention the phosphorus compound binding agent in the chewing gum is used as a special nutrition.

In an embodiment of the invention the phosphorus compound binding agent in the chewing gum is used for the support of the treatment of hyperphosphatemia.

In an embodiment of the invention a phosphorus compound binding agent in a slow release oral delivery system comprising chewing gum for reducing the level of free phosphorus compounds in the digestive juice according to any of the claims 38 to 48, wherein the chewing gum is according any of the claims 23-37.

In advantageous embodiments the above embodiments also comprise organic acid as an enhancer of the phosphorus binding ability.

In various embodiments of the method, the above-mentioned use embodiments may be used as well.

### BRIEF DESCRIPTION OF THE DRAWINGS

FIG. 1 illustrates the weight gain of the chewing gum residues for different formulations after chewing and drying.

FIG. 2 shows the effect of the amount of ascorbic acid on the phosphate binding ability of chitosan 1.

FIG. 3 shows the effect of the amount of ascorbic acid on the phosphate binding ability of chitosan 2.

### DETAILED DESCRIPTION

In the present context, the term “digestive juice” is generally used to indicate the various juices found within the human digestive tract, e.g. saliva, gastric juice, pancreatic juice, bile, and intestinal juice.

The term “binding affinity” herein means that a material is capable for binding to another material. Chitosan having fat-binding affinity thus means that chitosan is capable of binding fat.

In the present context, chitosan is called a phosphorus compound binding agent because it can bind phosphorus in a stable manner throughout the transit of the chitosan along the gastrointestinal tract. Examples of phosphorus binding are any kind of chemical bond, such as ionic bond, covalent bond, Van der Waals interactions, chelating phenomenon.

In the present context, the term “phosphorus compound” is intended any substance containing phosphorus, for example phosphate.

For the purposes of the present invention, oral delivery system is intended as any system comprising chewing gum which can be administered by oral route to a subject. Also for the purposes of the present invention, slow release oral delivery system is intended a system comprising chewing gum which releases in a continuous manner the chitosan in the gastrointestinal tract, oral environment included.

The oral delivery systems for the continuous slow release of chitosan cover any composition comprising chewing gum which, when retained in the mouth for a sufficient period of time, continuously releases chitosan in a slow manner. Chewing gum is a preferred oral delivery system according to the present invention. An advantage related to chewing gum is that saliva is a major source of recirculating phosphorus from the body and once the oral delivery system has bound a lot of phosphorus, it can be discarded from the mouth and possibly a new chewing gum can be taken. This avoids swallowing the composition and engaging the gastrointestinal tract with the presence of a composition loaded with phosphorus, so that the user has not to worry about a possible release of phosphorus in the gastrointestinal tract or the effective elimination of the composition.

The desired amount of chitosan in the oral delivery systems of the invention may vary. However, in a chewing gum, an amount should be sufficient to have an effect but at the same time avoid that the chewing gum is unpleasant to chew.

Preferred chitosan to be used according to embodiments of the present invention is low- and medium-viscosity chitosan (FLUKA cat. 50494 and cat. 28191).

Both chitosan and the organic acid, such as ascorbic acid, can be added to the oral delivery system comprising chewing gum by any suitable method known to the skilled person in the art. For example, these may be mixed with the gum base or added as part of the water-soluble chewing gum ingredients, or even a part of these may be part of an optional coating.

The composition of gum base formulations can vary substantially depending on the particular product to be prepared and on the desired masticatory and other sensory characteristics of the final product. However, typical ranges (% by weight) of the above ingredients in the gum base matrix are: 5 to 80% by weight elastomeric compounds, 5 to 80% by weight elastomer plasticizers, 0 to 40% by weight of waxes, 5 to 35% by weight softener, 0 to 50% by weight filler, and 0 to 5% by weight of miscellaneous ingredients such as antioxidants, colorants, etc. The gum base may comprise about 5 to about 95 percent, by weight, of the chewing gum, more commonly the gum base comprises 10 to about 60 percent, by weight, of the gum.

Elastomers provide the rubbery, cohesive nature to the gum, which varies depending on this ingredient's chemical structure and how it may be compounded with other ingredients. Elastomers suitable for use in the gum base and gum of the present invention may include natural or synthetic types.

Elastomer plasticizers vary the firmness of the gum base. Their specificity on elastomer inter-molecular chain breaking (plasticizing) along with their varying softening points cause varying degrees of finished gum firmness and compatibility when used in base. This may be important when one wants to provide more elastomeric chain exposure to the alkane chains of the waxes.

The elastomers (rubbers) employed in the gum base may vary depending upon various factors such as the type of gum base desired, the texture of gum composition desired and the other components used in the composition to make the final chewing gum product. Illustrative examples of suitable polymers in gum bases include both natural and synthetic elastomers. For example, those polymers which are suitable in gum base compositions include, without limitation, natural substances (of vegetable origin) such as chicle gum, natural rubber, crown gum, nispero, rosidinha, jelutong, perillo, niger gutta, tunu, balata, guttapercha, lechi capsi, sorva, gutta kay, and the like, and mixtures thereof. Moreover, methyl vinyl ether-maleic anhydride copolymers may be added. Examples of synthetic elastomers include, without limitation, styrene-butadiene copolymers (SBR), polyisobutylene, isobutylene-isoprene copolymers, polyisoprene, polyethylene, polyvinyl acetate, vinyl acetate-vinyl laureate copolymer and the like, and mixtures thereof.

Natural resins may be used according to the invention and may be natural rosin esters, often referred to as ester gums including as examples glycerol esters of partially hydrogenated rosins, glycerol esters of polymerised rosins, glycerol esters of partially dimerized rosins, glycerol esters of tally oil rosins, pentaerythritol esters of partially hydrogenated rosins, methyl esters of rosins, partially hydrogenated methyl esters of rosins, pentaerythritol esters of rosins, synthetic resins such as terpene resins derived from alpha-pinene, beta-pinene, and/or d-limonene, and natural terpene resins.

In an embodiment of the invention, the resin comprises terpene resins, e.g. derived from alpha-pinene, beta-pinene, and/or d-limonene, natural terpene resins, glycerol esters of gum rosins, tall oil rosins, wood rosins or other derivatives thereof such as glycerol esters of partially hydrogenated rosins, glycerol esters of polymerized rosins, glycerol esters of partially dimerised rosins, pentaerythritol esters of partially hydrogenated rosins, methyl esters of rosins, partially hydrogenated methyl esters of rosins or pentaerythritol esters of rosins and combinations thereof.

Gum bases are typically prepared by adding an amount of the elastomer, elastomer plasticizer and filler, and on occasion a vinyl polymer, to a heated (10° C.-120° C.) sigma blade mixer with a front to rear speed ratio of from about 1.2:1 to about 2:1, the higher ratio typically being used for gum base which requires more rigorous compounding of its elastomers.

In an embodiment of the invention, said chewing gum comprises said gum base matrix and one or more chewing gum ingredients.

In an embodiment of the invention, said chewing gum ingredients are selected from the group consisting of bulk sweeteners, flavors, dry-binders, tabletting aids, anti-caking agents, emulsifiers, antioxidants, enhancers, absorption enhancers, buffers, high intensity sweeteners, softeners, colors, or any combination thereof.

In addition to the above water-insoluble gum base composition, the bulk portion comprises a generally water-soluble part comprising a range of chewing gum additives. In the present context, the term “chewing gum additive” is used to designate any component, which in a conventional chewing gum manufacturing process is added to the bulk portion. The major proportion of such conventionally used additives is water soluble, but water-insoluble components, such as e.g. water-insoluble flavoring compounds, can also be included.

In the present context, chewing gum additives include bulk sweeteners, high intensity sweeteners, flavoring agents, softeners, emulsifiers, coloring agents, binding agents, acidulants, fillers, antioxidants and other components such as pharmaceutically or biologically active substances, conferring desired properties to the finished chewing gum product.

Suitable bulk sweeteners include both sugar and non-sugar sweetening components. Bulk sweeteners typically constitute from about 5 to about 95% by weight of the chewing gum, more typically about 20 to about 80% by weight such as 30 to 70% or 30 to 60% by weight of the gum.

Useful sugar sweeteners are saccharide-containing components commonly known in the chewing gum art including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomalt, erythritol, lactitol, inulin and the like, alone or in combination.

High intensity artificial sweetening agents can also be used alone or in combination with the above sweeteners. Preferred high intensity sweeteners include, but are not limited to sucralose, aspartame, salts of acesulfame, alitame, saccharin and its salts, cyclamic acid and its salts, glycyrrhizin, dihydrochalcones, thaumatin, monellin, stevioside and the like, alone or in combination.

Usage level of the artificial sweetener will vary considerably and will depend on factors such as potency of the sweetener, rate of release, desired sweetness of the product, level and type of flavor used and cost considerations. Thus, the active level of artificial sweetener may vary from about 0.001 to about 8% by weight (preferably from about 0.02 to about 8% by weight). When carriers used for encapsulation are included, the usage level of the encapsulated sweetener will be proportionately higher. Combinations of sugar and/or non-sugar sweeteners can be used in the chewing gum composition processed in accordance with the invention. Additionally, the softener may also provide additional sweetness such as with aqueous sugar or alditol solutions.

In an embodiment of the invention, the chewing gum comprises one or more chewing gum ingredients selected from the group consisting of bulk sweeteners, flavors, dry-binders, tabletting aids, anti-caking agents, emulsifiers, antioxidants, enhancers, absorption enhancers, buffers, or any combination thereof.

Further useful chewing gum base include antioxidants, e.g. butylated hydroxytoluene (BHT), butyl hydroxyanisol (BHA), propylgallate and tocopherols, and preservatives.

A gum base formulation may, in accordance with the present invention, comprise one or more softening agents e.g. sucrose esters, tallow, hydrogenated tallow, hydrogenated and partially hydrogenated vegetable oils, cocoa butter, degreased cocoa powder, glycerol monostearate, glyceryl triacetate, lecithin, mono-, di- and triglycerides, acetylated monoglycerides, lanolin, sodium stearate, potassium stearate, glyceryl lecithin, propylene glycol monostearate, glycerine, fatty acids (e.g. stearic, palmitic, oleic and linoleic acids) and combinations thereof. As used herein the term “softener” designates an ingredient, which softens the gum base or chewing gum composition and encompasses waxes, fats, oils, emulsifiers, surfactants and solubilisers. Softeners are typically used in an amount of 0 to 18% by weight, preferably 0 to 12% by weight of the gum base.

Useful emulsifiers can include, but are not limited to, glyceryl monostearate, propylene glycol monostearate, mono- and diglycerides of edible fatty acids, lactic acid esters and acetic acid esters of mono- and diglycerides of edible fatty acids, acetylated mono and diglycerides, sugar esters of edible fatty acids, Na-, K-, Mg- and Ca-stearates, lecithin, hydroxylated lecithin and the like and mixtures thereof are examples of conventionally used emulsifiers which can be added to the chewing gum base. In case of the presence of a biologically or pharmaceutically active ingredient as defined below, the formulation may comprise certain specific emulsifiers and/or solubilisers in order to disperse and release the active ingredient.

Waxes and fats are conventionally used for the adjustment of the texture and for softening of the chewing gum base when preparing chewing gum bases. In connection with the present invention, any conventionally used and suitable type of natural and synthetic wax and fat may be used, such as for instance rice bran wax, polyethylene wax, petroleum wax (refined paraffin and microcrystalline wax), sorbitan monostearate, tallow, propylene glycol, paraffin, beeswax, carnauba wax, candelilla wax, cocoa butter, degreased cocoa powder and any suitable oil or fat, as e.g. completely or partially hydrogenated vegetable oils or completely or partially hydrogenated animal fats.

A chewing gum base may, if desired, include one or more fillers/texturisers including as examples, magnesium and calcium carbonate, sodium sulphate, ground limestone, silicate compounds such as magnesium and aluminum silicate, kaolin and clay, aluminum oxide, silicium oxide, talc, titanium oxide, mono-, di- and tri-calcium phosphates, cellulose polymers, such as wood, and combinations thereof.

In an embodiment of the invention, said chewing gum comprises a biodegradable gum base polymer.

In an embodiment of the invention, the chewing gum is provided with an outer coating selected from the group consisting of hard coating, soft coating and edible film-coating or any combination thereof.

### EXAMPLES

### Example 1

General Binding Properties of Chitosan with or without Ascorbic Acid

The following example is carried out at a pH of 6.4.

About 250 mg sample is weighed into a conical flask and is added 50 ml phosphate solution with 120 ppm phosphate. The solution is stirred for 30 minutes. 2×1 ml is used for a SPE column (Oasis MCX 3cc). 1 ml is discarded; 2 ml is collected and analyzed for phosphate content by ion chromatography. In case no phosphate-binding occurs, the content of free phosphate is expected to be 120 ppm in the samples. The measured content is used to calculate how much phosphate is bound for each gram of sample. The results can be seen in table 1.

TABLE 1
Chitosan phosphate binding properties

| | | | Bound |
|---|---|---|---|
| Sample | Ascorbic acid | Free phosphate (ppm) | phosphate (mg/g) |
| Water | No | 0 | N/A |
| Phosphate | No | 118 | N/A |
| solution | | | |
| Chitosan- | No | 85 | 7.0 |
| product 1 | Yes | 48 | 14.4 |
| Chitosan- | No | 59 | 12.2 |
| product 2 | Yes | 52 | 13.6 |

Conclusion

Chitosan-product 2 binds more phosphate than Chitosan-product 1. The addition of ascorbic acid increases the phosphate binding, especially for chitosan product 1.

### Example 2

Weight Gain of Chewing Gum Residues Comprising Chitosan and Ascorbic Acid

By comparing the weight difference of chewing gum residue with and without chitosan and organic acid it is possible to get an indication of the binding ability of chitosan and the release of chitosan from the chewing gum.

Samples were chewed on a chewing machine (European Pharmacopeia 4 th. ed. 2.9.25 Chewing gum medicated, drug release from) in a phosphate buffer (phosphate concentration 285 mg/l) with a pH of 7.4 for 20 min. The chewing gum residue remaining after chewing is dried in a vacuum oven at 50° C. during night.

TABLE 2
Recovery of chitosan in chewing gum residue

| | | | | | | Chitosan | | |
|---|---|---|---|---|---|---|---|---|
| | | Weight of chewing gum residue | | | | Recovery of | Recovery of | |
| | | | St. | RSD | Theoretical | chitosan | chitosan | Release |
| Formulation | Description | Average | dev. | [%] | weight [mg] | [mg] | [%] | [%] |
| CG8 | Placebo | 842 | 18.5 | 2.2% | 842 | | | |
| CG9 | 20 mg | 885 | 10.4 | 1.18% | 862 | 43 | 217 | 0 |
| | Chitosan | | | | | | | |
| CG10 | 20 mg | 922 | 25.2 | 2.74% | 862 | 80 | 402 | 0 |
| | Chitosan + | | | | | | | |
| | 8.8 mg | | | | | | | |
| | Ascobic | | | | | | | |
| | acid | | | | | | | |
| CG11 | 20 mg | 981 | 21.7 | 2.21% | 862 | 139 | 697 | 0 |
| | Chitosan + | | | | | | | |
| | 88 mg | | | | | | | |
| | Ascobic | | | | | | | |
| | acid | | | | | | | |

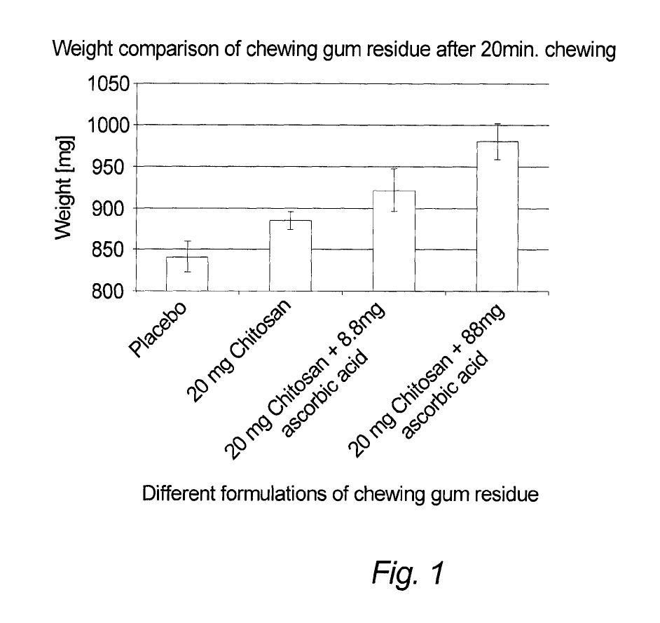

FIG. 1 illustrates the weight gain of the chewing gum residues for different formulations after chewing and drying.

Conclusion

As both table 2 and FIG. 1 show, the weight of the chewing gum residue increases by adding chitosan and further increases are seen by adding organic acid and also by increasing the amount of organic acid. This weight increase for the chewing gum residue indicates the ability to bind phosphate in the chewing gum residue and also that remaining chitosan is still available in this residue.

The results further indicate that water may still be present in the chewing gum residue. It is to be noted that small amounts of chitosan may actually be released from the chewing gum during chewing, but this release is masked by the weight gain of the residue.

### Example 3

Release of Chitosan when Different GB System is Used

TABLE 3
Release of chitosan from chewing gum

| | | Relative |
|---|---|---|
| Formulation | Description | release |
| CG12 | GB1 | + |
| CG13 | GB2 | ++++ |
| CG14 | GB3 | ++ |
| CG15 | GB4 | + |

Conclusion

In table 3, “relative release” relates to the amount of chitosan released in a chewing process when different gum bases are compared.

As table 3 shows it is important to choose the right GB system to achieve the preferred release. If the retaining of Chitosan in the gum is preferable, the GB systems GB1 and GB4 in formulations CG12 and CG15 are the best choice.

### Example 4

Optimizing the Enhancing Effect of Organic Acid

The organic acid has a comparatively rapid release from the chewing gum. To obtain the increased binding effect between chitosan and phosphate by adding acid it is necessary to have the organic acid available long enough to establish the increased effect.

TABLE 4
Effect of encapsulation of acid on phosphate binding in
chewing gum comprising chitosan.

| | | Amount of bound |
|---|---|---|
| | | phosphate in the chewing |
| | | gum residue |
| Formulation | Description | [mg phosphate/g chitosan] |
| CG16 | Free organic acid | 7.4 |
| CG17 | Encapsulate organic acid | 9.7 |
| CG18 | Special encapsulation of | 11.8 |
| | organic acid-1 | |
| CG19 | Special encapsulation of | 12.9 |
| | organic acid-2 | |

Conclusion

As shown in table 4, it is important to choose the right encapsulation system for the organic acid to achieve the best phosphate binding effect. Therefore the acid system used in CG18 and CG19 is the best choose.

### Example 5

Detailed Effect of Organic Acids

Some organic acids have a positive effect of Chitosan ability to bind phosphate The following organic acid has been tested for Chitosan 1 and Chitosan 2:
Ascorbic acid (pKa=4.3), tested at different levels
Citric acid (pKa=3.1), only one level is tested
Malic acid (pKa=3.4), only one level is tested
Tataric acid (pKa=3.0), only one level is tested
The binding of phosphate is not proportional to the amount of organic acid added and the effect is different for each type of Chitosan

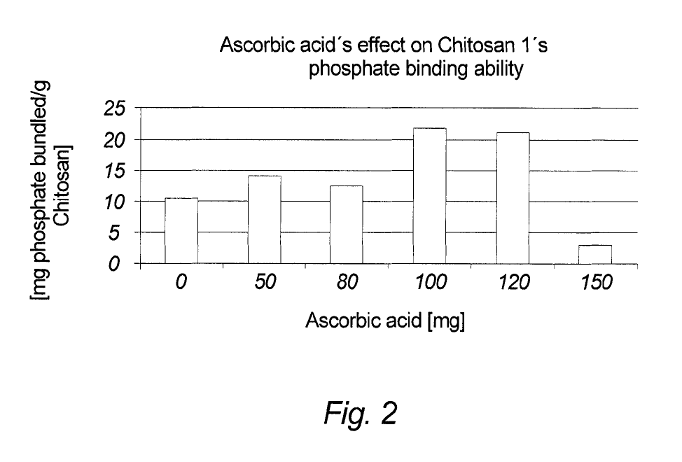

FIG. 2 shows the effect of the amount of ascorbic acid on the phosphate binding ability of chitosan 1.

Measurements are based on a water solution of different amounts of ascorbic acid where 250 mg Chitosan 1 is added to a solution with known phosphate concentration.

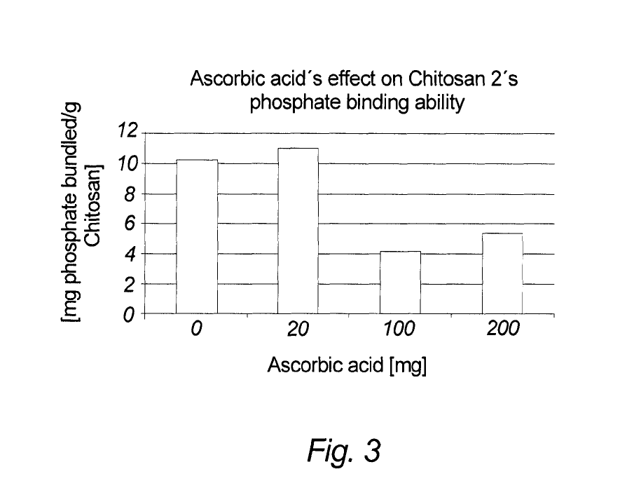

FIG. 3 shows the effect of the amount of ascorbic acid on the phosphate binding ability of chitosan 2.

Measurements are based on a water solution of different amounts of ascorbic acid where 250 mg Chitosan 1 is added to a solution with known phosphate concentration.

Type and amount of organic acid:

TABLE 5
Effect of acid types for phosphate binding ability
Effect of acid types for phosphate binding ability

| | [mg phosphate bounded/g Chitosan] | |
|---|---|---|
| | 250 mg Chitosan 1 + | 250 mg Chitosan 2 + |
| Type of organic acid | 100 mg acid | 20 mg acid |
| No acid | 11 | 8 |
| Ascorbic acid | 22 | 12 |
| Citric acid | 2 | 8 |
| Malic acid | 21 | 24 |
| Tartaric acid | 22 | 23 |

It is seen from the results listed in Table 5 that chitosan 2 in combination with malic or tartaric acid has the largest effect on phosphate binding, with the lowest amount of acid added.

### Example 6

Chewing Gum Formulation for a Two Layer Compressed Chewing Gum Tablet

TABLE 6
Chewing gum composition
Compressed formulation

| | Raw material | Amount [%] |
|---|---|---|
| Layer 1 | GB 1 | 40 |
| | GB 2 | |
| | Bulk sweetener | 35 |
| | High intensive sweetener | 0.25 |
| | Organic acid | 0.48 |
| | Chitosan | 1.1 |
| | Flavour | 4.0 |
| Layer 2 | Bulk sweetener | 19 |
| | High intensive sweetener | 0.05 |
| | Flavour | 0.12 |

In table 6, an example of a chewing gum composition for reducing the amount of phosphorus in the digestive juice, is given. In this case, chitosan and organic acid are mixed into the gum base-containing layer of a two layer compressed chewing gum tablet.

What is claimed is:

1. A method of reducing the level of free phosphorus compounds in digestive juice to alleviate hyperphosphatemia by the use of chewing gum comprising:
a water insoluble gum base; and
a combination of:
chitosan as a phosphorus compound binding agent; and
at least one organic acid selected from the group consisting of ascorbic acid, malic acid, and tartaric acid.

2. The method according to claim 1, wherein the chewing gum comprises organic acid in an amount of 0.01 to 10% by weight of the chewing gum.

3. The method according to claim 1, wherein the chewing gum comprises organic acid in an amount of 0.05 to 2% by weight of the chewing gum.

4. The method according to claim 1, wherein said chewing gum is an extruded chewing gum.

5. The method according to claim 4, wherein said extruded chewing gum comprises gum base in an amount of 10 to 70% by weight of the chewing gum.

6. The method according to claim 1, wherein said chewing gum is compressed chewing gum.

7. The method according to claim 6, wherein said compressed chewing gum comprises gum base in an amount of 5 to 50% by weight of the chewing gum.

8. The method according to claim 1, wherein said chewing gum comprises sweetener in an amount of 5 to 80% of the chewing gum.

9. The method according to claim 1, wherein the chewing gum comprises chitosan in an amount of 0.1 to 10% by weight of the chewing gum.

10. The method according to claim 1, wherein the chewing gum comprises chitosan in an amount of 0.4 to 2% by weight of the chewing gum.

11. The method according to claim 1, wherein a chewing gum tablet comprises chitosan in an amount of 5 to 100 mg.

12. The method according to claim 1, wherein a chewing gum tablet comprises chitosan in an amount of 15 to 60 mg.

13. The method according to claim 1, wherein a ratio between an amount of chitosan and an amount of gum base in the chewing gum is between 0.001 to 0.15.

14. The method according to claim 1, wherein said chewing gum comprises a chewing gum tablet, wherein the chewing gum tablet is compressed and comprises chewing gum granules, wherein said chewing gum granules comprises gum base,
wherein said chewing gum tablet comprises a gum base content of at least 5% by weight of the tablet,
wherein said chewing gum tablet comprises chitosan in an amount of at least 1% by weight of the tablet,
wherein said chitosan has a molecular weight of above 30.000 Da,
wherein said chitosan has a degree of deacetylation above 85%, and
wherein said chewing gum tablet comprises ascorbic acid in an amount of at least 0.1% by weight of the tablet.

15. The method according to claim 1, wherein said chewing gum comprises a chewing gum tablet, wherein said chewing gum tablet has a gum base content of 5-90% by weight of the tablet,
wherein said chewing gum tablet comprises chitosan in an amount of at least 0.05% by weight of the tablet,
wherein said chitosan has a molecular weight of above 30.000 Da,
wherein said chitosan has a degree of deacetylation above 85%, and
wherein said chewing gum tablet comprises ascorbic acid in an amount of at least 0.1% by weight of the tablet.

16. The method according to claim 1, wherein said chewing gum comprises a chewing gum tablet, wherein said chewing gum tablet comprises chewing gum granules, wherein said chewing gum granules comprise gum base,
wherein said chewing gum tablet has a gum base content of 5-90% by weight of the tablet,
wherein said chewing gum tablet comprises chitosan in an amount of at least 0.1% by weight of the tablet,
wherein said chitosan has a molecular weight of above 30.000 Da,
wherein said chitosan has a degree of deacetylation above 85%, and
wherein said chewing gum tablet comprises ascorbic acid in an amount of at least 0.1% by weight of the tablet.

17. A phosphorus compound binding agent in a slow release oral delivery system comprising the chewing gum used in the method of claim 1 for reducing the level of free phosphorus compounds in the digestive juice, for the support of treatment of patients with chronic renal insufficiency, wherein said phosphorus compound binding agent is chitosan.

18. The phosphorus compound binding agent in a slow release oral delivery system according to claim 17 wherein said phosphorus compound binding agent is chitosan and wherein the chewing gum further comprises an organic acid.

19. The method according to claim 5 wherein said extruded chewing gum comprises gum base in an amount of 15 to 60% by weight of the chewing gum.

20. The method according to claim 19 wherein said extruded chewing gum comprises gum base in an amount of 35 to 50% by weight of the chewing gum.

21. The method according to claim 7 wherein said compressed chewing gum comprises gum base in an amount of 8 to 40% by weight of the chewing gum.

22. The method according to claim 21 wherein said compressed chewing gum comprises gum base in an amount of 10 to 30% by weight of the chewing gum.

23. A method of reducing a level of free phosphorus compounds in digestive juice to alleviate hyperphosphatemia by the use of a chewing gum comprising:
a water insoluble gum base; and
a combination of
chitosan as a phosphorus compound binding agent; and
at least one organic acid.

24. A method of reducing a level of free phosphorus compounds in digestive juice to alleviate hyperphosphatemia by the use of:
a combination of
chitosan as a phosphorus compound binding agent; and
at least one organic acid selected from the group consisting of ascorbic acid, malic acid, and tartaric acid,
comprised in a chewing gum comprising a water insoluble gum base.

25. A method of reducing a level of free phosphorus compounds in digestive juice to alleviate hyperphosphatemia by the use of:
a combination of
chitosan as a phosphorus compound binding agent; and
at least one organic acid,
comprised in a chewing gum comprising a water insoluble gum base.
